(19) United States
(12) Patent Application Publication
(10) Pub. No.: US 2004/0015567 A1
(43) Pub. Date: Jan. 22, 2004

(54) Hierarchical client aware content aggregation in a wireless portal system

(76) Inventors: Gregory J. Ziebold, Superior, CO (US); Thomas R. Mueller, Fremont, NE (US); Jeffrey T. Blattman, San Jose, CA (US); Luu D. Tran, Santa Clara, CA (US)

Correspondence Address: WAGNER, MURABITO & HAO LLP, Third Floor, Two North Market Street, San Jose, CA, 95113, US

(21) Appl. No.: 10/621,847

(22) Filed: Jul. 16, 2003

Related U.S. Application Data
(63) Continuation-in-part of application No. 09/929,545, filed on Aug. 13, 2001.

(51) Int. Cl. G06F 15/16

(52) U.S. Cl. 709/219

(57) ABSTRACT

A wireless portal system has a wireless server with a hierarchical client aware content aggregation method and system. The client aware content aggregation system includes logic for identifying client wireless devices connecting to the wireless server by using particular characteristics of the client in presenting content selected in response to connection requests from the client to the server. In one embodiment of the invention, the client aware content aggregation system receives an indication of a client type and uses this information to automatically search for content from a configurable set of web-sites on the Internet and formats content selected by the end-user for delivery to the client.

### CROSS REFERENCE TO RELATED APPLICATION

This patent application is related to co-pending patent application serial number______, filed on______, by Luu Tran et al., entitled “System and Method for Client Aware Request Dispatching in a Portal Server ”, attorney docket No.: SUN-P030066 and is a continuation-in-part of commonly assigned co-pending U.S. patent application Ser. No. 09/929,545, filed on 08/13/01, by Kavacheri et al., entitled “Client Aware Content Scraping and Aggregation in a Wireless Portal System”, which are hereby incorporated herein by reference in their entirety.

This Application is related to the following commonly owned co-pending U.S. Patent Applications: “System and Method for Client Aware Request Dispatching in a Portal Server, ” by Ziebold et al., filed on ______, Serial No. Attorney Docket No. SUN-P030066; “Hierarchical Client Detection in a Wireless Portal Server, ” by Kavacheri et al., filed on______, Serial No.______, Attorney Docket No. SUN-P030067; “Extensible Customizable Structured and Managed Client Data Storage,” by Kavacheri et al., filed on______, Serial No.______ Attorney Docket No. SUN-P030090; the contents of which are incorporated herein by reference.

### FIELD OF THE INVENTION

The present claimed invention relates generally to the field of wireless communication systems. More particularly, the present claimed invention relates to client aware content scraping and aggregation in a client independent wireless environment.

### BACKGROUND ART

The Internet has become the dominant vehicle for data communications. And with the growth of Internet usage has come a corresponding growth in the usage of Internet devices, wireless devices and services.

The growing base of Internet users has become accustomed to readily accessing Internet-based services such electronic mail, calendar or content at any time from any location. These services, however, have traditionally been accessible primarily through stationary desktop computers. However, demand is now building for easy access to these and other communication services for mobile devices.

As the demand for mobile and wireless devices increases, enterprises rollout new communication capabilities beyond the reach of traditional wired devices, by extending the enterprise with extra-net applications, etc., to effectively and efficiently connect mobile employees with their home base.

As the number of digital subscribers grows, traditional wireless providers desire to find applications suitable to the needs of these new mobile users.

In addition to service providers seeking applications to meet the growing service needs of wireless users, traditional portal developers are also extending their traditional browser desk-top services to these new wireless markets.

With the growth of the wireless market comes a corresponding growth in wireless business opportunities, which in today's ever-growing markets means, there is a plethora of services available to customers of the enterprises that use these services. Many wireless service providers are now looking to increase core services by extending services such as e-mail, short messaging service notification, and other links to Internet Protocol (IP) based applications to drive additional business and revenues.

As the wireless market grows and Internet access becomes more mainstream and begins to move to new devices, wireless service providers are looking to develop highly leveraged Internet Protocol based applications on top of existing network infrastructure. To meet the growing demand for wireless client devices, enterprises need to provide access to any type of service from any type of device from anywhere and need to provide content suitable for these devices without incurring substantial cost overhead.

The growth in wireless devices also means that traditional computer users who were tied to their desktop computers may now be mobile and would require remote access to network applications and services such as email. The mobility of wireless users presents a host of challenges to service providers who may have to provide traditional service to these new wireless devices. One such service is provided by Sun Microsystems, Inc., through its SUN ONE™ platform to allow service providers to grow their services from basic traditional services such as voice to leading edge wireless applications with carrier-grade reliability and performance.

In addition to the traditional network applications that these new wireless users seek, the growth of the Internet and the introduction of new Internet enabled wireless devices have led to the explosive use of community-based web sites or portals. This growth in portals has created a need for wireless environments to provide portal support to handle the collection of data related to different topics such as news, stock quotes, applications and services required by wireless device users.

FIG. 1 depicts an exemplary prior art wireless client dependent based environment solution to handle similarly configured wireless client running similar applications or portals. The environment depicted in FIG. 1 includes wireless devices such as a Wireless Applications Protocol (WAP) phone 101, a wireless PC 102, appliance 103, etc. In general, the wireless environment depicted in FIG. 1 is categorized into the network (Internet 104), clients (e.g. mobile phone 101, PCs 102 and household appliances 103) and resources (e.g., web-sites 105, portals 106 and other applications 107).

For most of the wireless clients connected to the Internet 104, portals 106 offer the client the starting point of experiencing the Internet 104. Portals 106 are typically individually customized web pages or sites that securely hold a collection of data related to different topics, including such applications as news, stock quotes, etc. For example, a wireless client connecting to the Internet will first login to a web portal site (e.g., yahoo) and from there browse through various sites to search for a host of different services.

The portals typically reside in a portal server which bundles an aggregation of services provided by an Internet service provider and provides these services to wireless clients. A wireless portal server such as that developed by Sun Microsystems, Inc. provides such portal access to wireless application resources residing on resource servers A 108, B 109 and C 110.

The prior art wireless server depicted in FIG. 1 primarily supports the two major types of browsers known by most Internet users. These include the Microsoft Internet Explorer Browser and the Netscape Communicator Browser. These browsers are both HyperText Markup Language (HTML) based and suitable for some wireless devices, especially devices with large display screens. However, as wireless display screens get smaller in size, traditional HTML browsers are no longer suitable for transmitting content to these wireless devices.

To ensure suitable content delivery, wireless device and wireless software providers have developed a myriad of micro-browsers that appropriately adapt to these wireless devices with different display screen requirements in order to take advantage of the numerous contents on the Internet. The availability of these new micro-browsers means that service providers do not have to create different sets of content for different wireless devices even if the devices are dissimilar.

In the prior art system depicted in FIG. 1, content delivery is primarily performed in HTML over such protocols as HTTP. This content is suitable for devices with wider screen display such as desktop or wireless PCs. Due to the large screen displays these prior art systems have, a resource server does not have to format content prior to delivery to these devices.

Thus, for the prior art server to support the various types of wireless client that service provider's support, a system's administrator painstakingly manually adds client specific content to support each wireless client if and when the client attempts to access the server.

Content delivery by a service provider in the prior art system depicted in FIG. 1 is typically conducted by syndication. In this process, the service provider is able to gather content from multiple web-sites and aggregate (syndicate) the content to give the appearance that the service provider is the original source of the syndicated content. In this prior art content syndication method, the syndicated content is only suitable for wireless devices of the same or similar configuration.

Content aggregation from multiple sites looks fine in most prior art cases except for devices that require strictly formatted content, e.g., wireless phones or hand-held devices. For HTML devices, the service provider could aggregate some well known markup tags and modify links embedded in, for example, the Uniform Resource Locator (URL) to reference URL resources through the service provider's system. However, as wireless devices proliferate and the configurations of these devices differ, the prior art method of syndicating content aggregated from multiple web-sites, while giving the appearance that the content is emanating from a single site, for presentation to these devices is unable to provide suitable formatted content for such devices. This is because many of the sites being aggregated do not have the ability or capability to provide content in a client aware manner, i.e., based on specific client type information.

As the number of models of wireless clients increase, having restricted content and very limited information about client characteristics impairs the ability of service providers to take advantage of new wireless technologies and provide efficient and cost effective services. This also impairs the ability of the wireless client to enjoy the full richness and look and feel of user interfaces provided by the server.

### SUMMARY OF INVENTION

Accordingly, to take advantage of the myriad of wireless applications and the numerous wireless clients being developed, a wireless server is needed with capabilities to allow content delivery to wireless clients to be configured based on pre-defined client type and formatted by the wireless server. A need exists for “out-of-the-box” wireless client aware system solutions to allow end-users to connect to the wireless environment without unduly tasking the end-user's technical abilities. A need further exists for an improved and less costly device independent system, which improves efficiency and provides content to various wireless clients of different configurations without losing the embedded features designed for these devices.

A wireless portal system has a wireless server with a hierarchical client aware content aggregation method and system. In general, embodiments of the present invention vary the degree of aggregating content for a wireless client connecting to the wireless environment by implementing a hierarchical search of predefined content stored in the wireless portal server to retrieve aggregated content for each specific client. The client aware content aggregation system includes logic for hierarchically identifying client data for client wireless devices connecting to the wireless portal server by using particular characteristics of the client in presenting content selected by a user in response to connection requests from the client to the wireless portal server. In one embodiment of the invention, the client aware content aggregation system receives an indication of a client type and uses this information to automatically perform a hierarchical search for content from a variety of predefined web content from the Internet configured by an administrator and formats the content identified for the end-user for delivery to the client. The aggregating logic further allows content selected for a particular end-user to be aggregated in a format suitable for delivery to the particular client device being used by the user.

Embodiments of the present invention are directed to a system and a method for wireless client aware content aggregation in a wireless network environment. In general, embodiments of the present invention vary the degree of providing content gathered from a variety of web-sites to a wireless client connecting to the wireless environment based on a hierarchical predefined content for a particular client from a list of predecessor ancestor devices. The present invention implements a hierarchical client aware content retrieval process to retrieve content based on detailed client type information. In other words, the invention provides client specific content aggregation of content aggregated from various web-sites and presented in a wireless network environment. The invention is suitably adapted to function in a wireless portal environment.

Embodiments of the invention include an integrated Internet content management solution designed to improve the availability of Internet content gathered from a variety of web-sites for delivery to a variety of differently configured wireless clients based on client type information specified by the client to a wireless server in a hierarchical manner. The present invention allows each client to maintain a property attribute that defines a list of predecessor ancestor devices of a particular client. The ancestor list enables content to be specifically aggregated for the client based on the predefined content of its ancestors.

Embodiments of the invention include a content aggregator to dynamically search back-end services in the wireless environment for end-user specified content for delivery to the client's home page in the wireless server. The content scraper further uses a portal session based on the client type information provided by a client connecting to the wireless network. Information in the session is used to retrieve client specific content from back-end services connected to the wireless server.

Embodiments of the present invention allow wireless servers to hierarchically store predefined client data. The hierarchically stored client data enables each client in the hierarchy to be able to support an aggregation that is specific to that client and allows for a unique set of channels for displaying content.

Embodiments of the present invention further include client aware content container logic that creates a list of content channels used by the aggregation logic to gather content for a specific client. In other words, the client aware source logic acts as an index to the channels that points to the web-sites where content is aggregated. The wireless portal server uses the aggregation container to display a user's selected channel. The aggregation container further specifies properties unique to that particular container, including a list of channels for display in that container.

Embodiments of the present invention further include mapping logic for mapping each client in the client data hierarchy to a container name specific to that client. By mapping clients to containers, any client in the hierarchy can have its own specific aggregation of content.

In one embodiment, automatic client detection logic identifies the type or class of the client and stores this information into a client session data structure. The client session information can then be used by the content selection system to automatically access the most pertinent content data for the client using an intelligent file retrieval system. Client identification or class information can be used in automatically determining whether content desired by the client is available, selected and presentable to the client. The content selection system receives an indication of a client type and uses this information to automatically construct content available for the client.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrates embodiments of the invention and, together with the description, serve to explain the principles of the invention:

Prior Art FIG. 1 is a block diagram of a conventional device dependent wireless system;

FIG. 2 is a block diagram of an implementation of a device independent wireless system of an embodiment of the present invention;

FIG. 3 is a block diagram of an exemplary internal architecture of the wireless server of FIG. 2;

FIG. 4 is a block diagram of an embodiment of an internal architecture of a wireless content aggregator of an embodiment of the present invention; and

FIG. 5 is a computer implemented flow diagram of an exemplary implementation of the content aggregating procedure of one embodiment of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended Claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

The invention is directed to a system, an architecture, subsystem and method to manage a wireless client's content selection in a client independent wireless environment in a way superior to the prior art. In accordance with an aspect of the invention, a wireless server provides wireless hierarchical client aware content aggregation which enables specific client characteristics of devices to be used in determining the type of content to be presented by the wireless portal server.

In the following detailed description of the present invention, a system and method for a wireless Internet protocol based communication system are described. Numerous specific details are set forth in order to provide a thorough understanding of the present invention. However, it will be recognized by one skilled in the art that the present invention may be practiced without these specific details or with equivalents thereof.

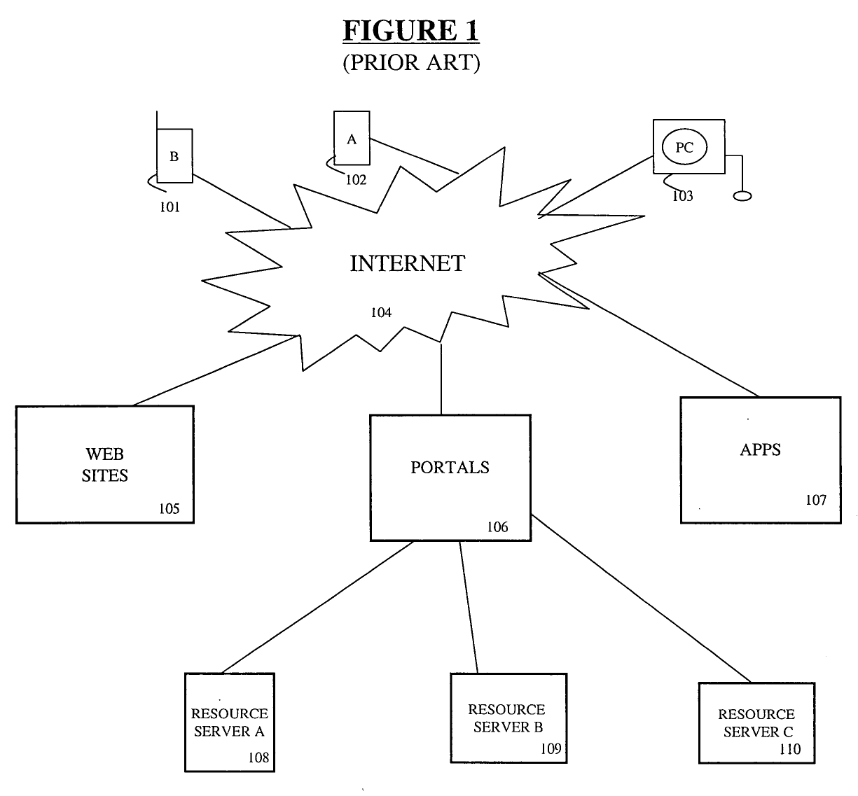

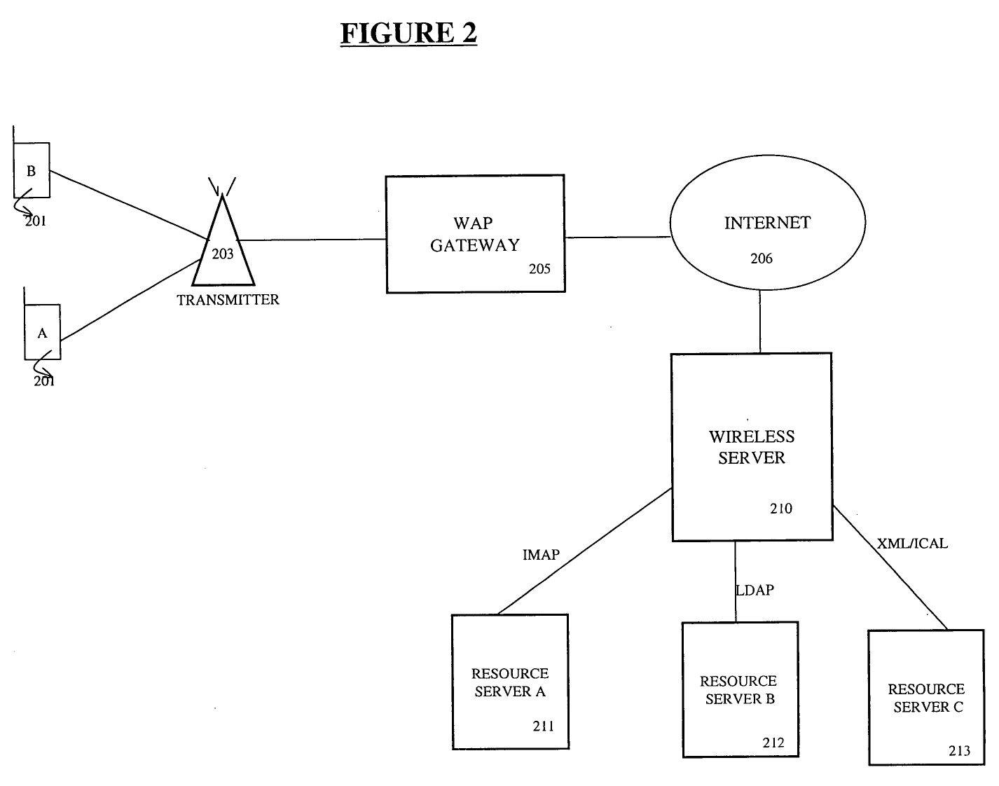

Generally, an aspect of the invention encompasses providing an integrated wireless Internet server which provides a wide range of voice, data, video and other services to wireless clients which may connect to the wireless environment to be serviced alongside predefined wireless clients. The embodiments of the invention can be more fully described with reference to FIGS. 2 through 6.

FIG. 2 depicts a wireless device independent based environment of the present invention. The wireless environment depicted in FIG. 2 comprises a wireless application protocol (WAP) based phone 201, a WAP transmission infrastructure 203, a WAP gateway 205, the Internet 206 and a wireless server 210. The WAP gateway 205 typically resides on the Local area network (LAN) within a telecom carrier premise. It is generally not a part of the wireless portal server 210. The WAP gateway 205 is responsible for converting the Wireless Markup Language (WML)/Hyper Text Transport Protocol (HTTP) content and protocol into a binary compressed, encoded, encrypted version of WML over WAP.

Conversely, the WAP gateway 205 also performs the translation of WAP commands into HTTP requests that can be sent over the public Internet 206. For example, in a GSM network, when a phone transmission is received by the mobile switching center, the gateway 205 distinguishes the transmission as packet data and sends it to the proper channel to be processed. The WAP gateway 205 decompresses and decrypts the packets, as well as several other functions and formats the data into an HTTP request that is sent to the wireless portal server 210. The WAP gateway 205 can also store user's bookmarks, two of which could point to the wireless portal server 210 messaging and other resource services. The wireless portal server 210 communicates Wireless Markup Language (WML) over HTTP on the front-end and communicates in native protocol of the target server on the back-end.

The wireless portal server 210 communicates to these back-end resource servers using the backend server's native protocol. For example, the wireless portal server 210 may communicate to resource server A 211 which may be a messaging server using IMAP. Lightweight Directory Access Protocol (LDAP) is used for all communications to and from the resource server B 212. And an Extensible Markup Language (XML) protocol may be used to communicate with resource server C 213.

Although the wireless portal server 210 depicted in FIG. 2 is capable of communicating in these native protocols shown in FIG. 2, the wireless portal server 210 protocol handling capability can be extended to support a variety of other protocols. For example, the wireless portal server 210 implements the WML interface that generates the corresponding WML content based on what it receives from the back-end server. The wireless portal server 210 also processes incoming HTTP requests in which a wireless device sends data or a request to the back-end servers to retrieve content. The wireless environment depicted in FIG. 2 typically supports wireless devices of dissimilar configuration or a class of similarly configured client devices and is therefore device independent and provides content to each client based on a hierarchical list of ancestry device information of each client.

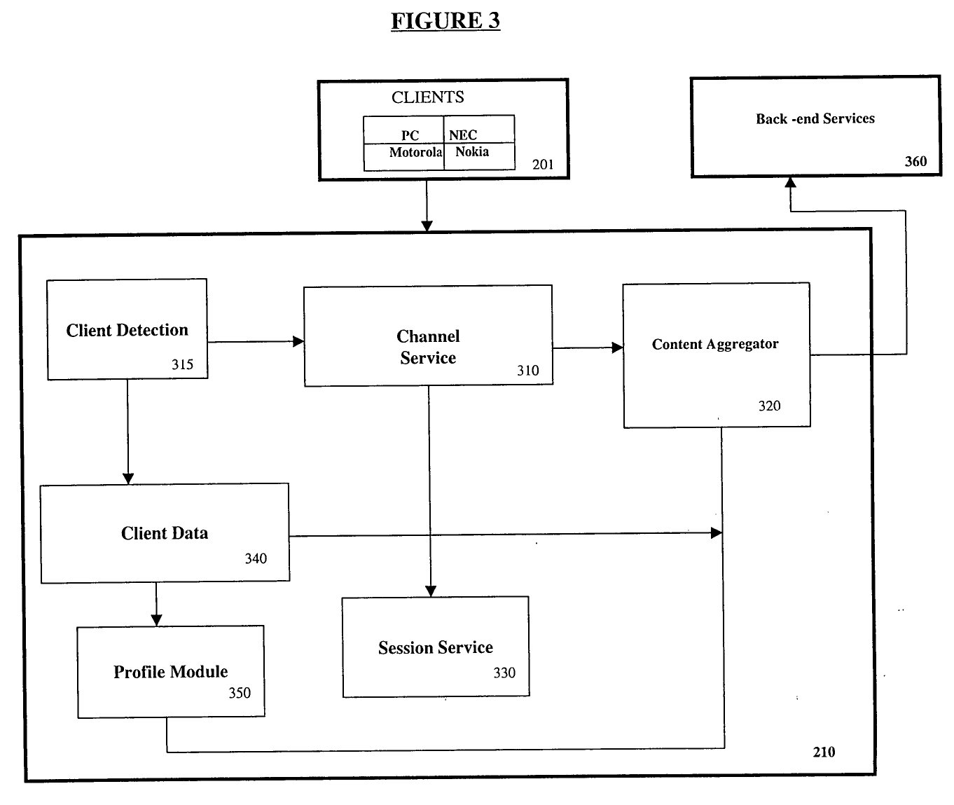

FIG. 3 is a block diagram illustration of one embodiment of the wireless server of the present invention. Wireless portal server 210 (WS) comprises, content provider service module 310, client detection module 315, content aggregator 320, session service (SS) module 330, client data module 340 and profile service (PS) module 350. The wireless portal server 210 also couples to back-end services 360 to retrieve content requested by the wireless clients connecting to the wireless portal server 210.

The wireless portal server 210 depicted in FIG. 3 is a flexible, scalable, extensible and capable of supporting a rich evolving range of networks such as Global System for Mobile communication (GSM) Networks, Code Division Multiple Access (CDMA) Networks, Time Division Multiple Access (TDMA) Networks, Third Generation (3G) Networks and others.

The architecture of the wireless portal server 210 is also capable of handling a variety of wireless environments and markup languages such as the wireless markup language (WML), the handheld device markup language (HDML) and the hypertext markup language (HTML). The wireless portal server 210 is capable of providing support for multiple wireless client devices and is easily adaptable and extensible to additional devices and markup languages.

Still referring to FIG. 3, provider service module 310 is coupled to provide a client with the ability to select content to user homepages and navigation links to other providers in the wireless portal server 210. An example of how an end-user can select content using the provider service 310 is described in commonly assigned co-pending U.S. patent application entitled “Client Aware Content Selection and Retrieval in a Wireless Portal System”, by Luu Tran et al. filed on Aug. 13, 2001, Ser. No.: 09/929,654, and is hereby incorporated by reference herein.

Content aggregator 320 is coupled to the provider service 310 and the client detection 315 to store content for all the defined client types of clients supported by the wireless portal server 210 in profile service 340. The content aggregator 320 parses incoming client requests to determine and extract client type information in order to deliver the corresponding content unique to the client in a format that is customized for the client.

In one embodiment of the present invention, profile attributes for each supported client type are predefined and pre-configured by the system administrator of the wireless portal server 210 and not by the end user. The content aggregator 320 enables a service provider to syndicate multiple content from a variety of web-sites into a single source for presentation to the wireless clients connecting to wireless portal server 210. In one embodiment of the present invention, content is aggregated from the variety of web-sites in a client aware manner and based on the hierarchical ancestry data of each wireless client in the client data 340.

In other words, content is aggregated in response to pertinent unique client information and characteristics provided by the client based on the predefined data of the client's ancestors (e.g., list of parent devices). In one embodiment of the present invention, the client data may include device profile, such as the markup languages of supported devices including WML, cHTML, HDML,HTML, iHTML, XHTML,JHTML and VoiceXML. And an example of a hierarchically stored client data may include for each profile, a device type, device manufacturer information, device software, screen type, etc.

For example,

TABLE 1

VoiceXML

Nuance

WML

Nokia

Nokia 3360
Nokia 3395
Nokia 63101
etc.

Ericsson T65
Motorola T280
etc.
WAP2

etc.

cHTML

Handspring Treo 180
etc.

Requests to the back-end service 360 are processed based on the client type information provided by the client detection service 315 of the wireless server 210. The Function of client detection module 315 is described in the commonly assigned co-pending U.S. Patent Application entitled “Hierarchical Client Aware Detection in a Wireless Portal Server,” by Kavacheri et. al, filed on, Attorney Docket No.: Sun-P030067/ACM/DKA, and is hereby incorporated herein by reference.

In the content aggregation environment of the present invention, when the content aggregator 320 provides content to multiple clients with different configurations, for example, a wireless phone 201c, a hand-held device 201b, a wireless PC 201d or a house-hold appliance 201a, etc., the wireless portal server 210 routes requests from the various clients to the appropriate back-end resource services depending on the client type. Therefore, the wireless portal server 210, using the content aggregator 320, could act as a proxy server if the content form a particular web-site does not have client awareness capabilities.

The content aggregator 320 uses the client data 340 to access a file path property of each client in the wireless portal server 210 to retrieve appropriate device specific templates. In the present invention, client data definitions are hierarchically stored in the client data module 340. By hierarchically storing the client definitions, each client device in the hierarchical structure is able to support an aggregation that is specific to that client device. It also allows for a unique set of channels for displaying content to the client device. The present invention provides methods to display specific content in the form of channels. For example, on an HTML device, these channels may appear as table cells and on WML devices the channels appear as links to WML cards containing the contents of the channel.

The profile module 350 maintains profile property attributes for each wireless client defined to have access to the wireless portal server 210. In one embodiment of the present invention, the property attribute includes a list of the ancestors of the client. The profile property attribute is used to track wireless clients selected for a particular user. This property is in turn used by the wireless client's configuration logic to list edit pages for the user's selected clients.

When a user first accesses the wireless portal server 210 with a new client device, the client type is inserted into a selected client collection property for the user. Thus, a user may add new devices simply by logging into the wireless portal server 210 instead of specifying a new client device to add from the client configuration provider. When the user wishes to remove the client from the selected client list, the user may use a remove client interface also through the client configuration provider.

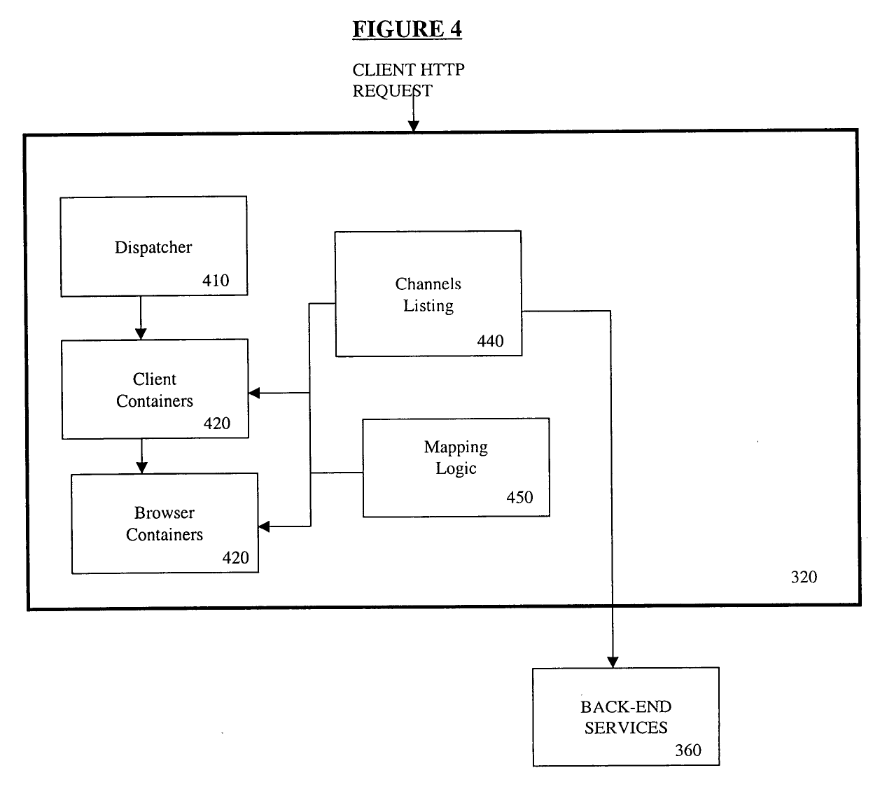

Reference is now made to FIG. 4 that is a block diagram illustration of one embodiment of the content aggregator 320 of the present invention. As depicted in FIG. 4, content aggregator 320 comprises a client requests dispatcher 410, client containers 420, browser containers 430, channel listing 440 and mapping logic 450.

The client requests dispatcher 410 processes all incoming client requests to the content aggregator 320. In one embodiment of the present invention, the client requests dispatcher 410 performs client type lookups from the client data 340 (FIG. 3) to determine from which content container in the client containers 420 to retrieve content for a particular client. The client requests dispatcher 410 implements a get client logic for client containers 420 to be read for a requesting client. The client requests dispatcher 410 reads client display profile from the profile module 350 (FIG. 3) and based on the client type calls the get content logic to the container specified for that particular client type. A select client display profile property logic tracks which wireless clients are selected for a user. The display profile property is in turn used by a client configuration provider to list edit pages for the users selected clients.

The client containers 420 store the predefined client specific channels provided by the channel listings 440 from which each client specified content may be selected. In one embodiment of the present invention, for each client, a user could specify a container from client containers 420 of the content to aggregate for the wireless client. Each client container 420 has an aggregation container to display the user's selected channels from the channel listing 440. The aggregation container can specify properties unique to that particular container including a list of channels for display in that container. The client containers 420 comprise default containers that have default list of channels predefined for each client type. When a user makes a change to the list of channels for a particular client type, the change is reflected in the appropriate default container. For example, the default channel list for a cHTML base profile device may include user information, book-mark information, mail, calendar, address-book, etc.

Each wireless client connecting to the client requests dispatcher 410 is mapped to one content container in client containers 420 by the mapping logic 450. In one embodiment of the present invention each client maps to only one content container. In one embodiment of the present invention, multiple clients may map to one particular content container in the client containers 420. Mapping clients to containers is performed for any client in the client data hierarchy to a container name specific to that client. Thus, any client hierarchy may have its own specific aggregation of content.

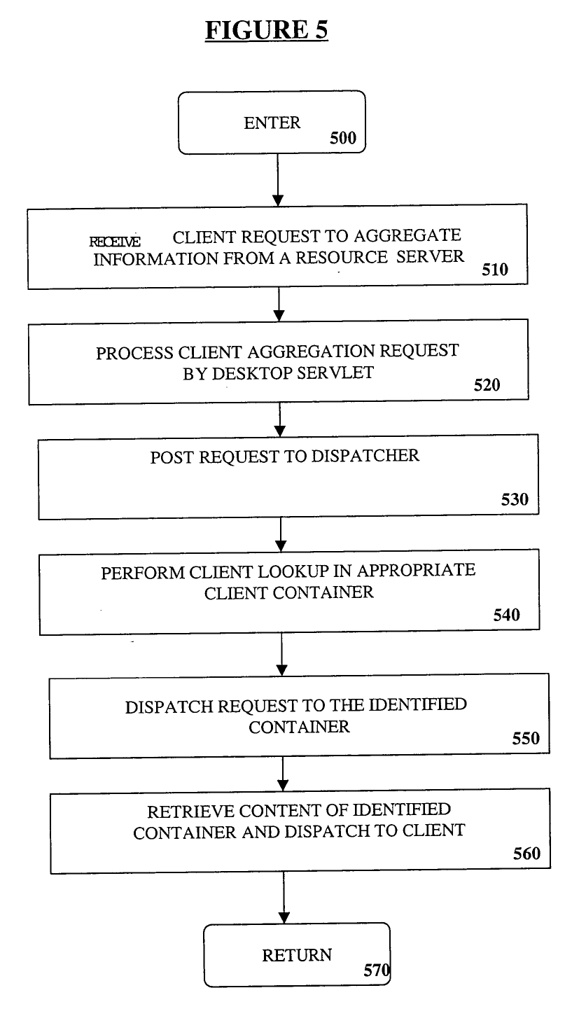

Reference is now made to FIG. 5 which is an exemplary computer implemented flow diagram of one embodiment of the hierarchical client aware content aggregation procedure of the present invention. The content aggregation procedures commences at step 500 when a wireless client initiates a content aggregation request to the wireless portal server 210. At step 510, the wireless portal server 210 forwards the client's request to the content aggregator 310. At step 520 the content aggregator 320 processes using a desktop servlet.

At step 530, the content aggregator 310 posts the clients request to the clients request dispatcher 410 which performs the appropriate client lookup based on the client type information at step 540.

At step 550, the client requests dispatcher 410 routes the clients requests to the appropriate client container 420 also base don the client type. At step 560, the identified client requested content is retrieved and dispatched to the client.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the Claims appended hereto and their equivalents.

1. A wireless portal server system comprising:
a plurality of content channels comprising wireless data defined as content containers;
a client data storage module for hierarchically storing predefined client data of a plurality of wireless clients defined to access said wireless portal server;
a client profile property module for storing property attributes that specifically define ancestry history of each wireless client connecting to said wireless portal server system; and
an applications content aggregator for aggregating content to a particular wireless client in a client aware manner based on said ancestry history of said particular wireless client and also for formatting selected content to said particular wireless client for presentation thereto.

2. The wireless portal server system of claim 1, wherein said applications content aggregator further displays a selected list of said plurality of content channels to said particular wireless client.

3. The wireless portal server system of claim 2, wherein said applications content aggregator specifies said property attributes to uniquely identify content for each one of said plurality of wireless clients.

4. The wireless portal server system of claim 3, wherein said applications content aggregator comprises a client request dispatcher for performing client lookups to determine the client type of a wireless client requesting access to said wireless portal server system.

5. The wireless portal server system of claim 4, wherein said client request dispatcher further performs a hierarchical search of said predefined client data to retrieve the appropriate aggregated content for said particular wireless client, said content comprising stored information pre-defining client type information of clients supported by said wireless server system.

6. The wireless portal server system of claim 5, wherein said applications content aggregator further comprises client content mapping logic for mapping each one of said plurality of wireless clients in a hierarchical predefined client data to a corresponding one of said plurality of content containers.

7. The wireless portal server system of claim 2, wherein said mapping logic further maps a plurality of said wireless clients to a corresponding one of said plurality of content containers.

8. The wireless portal server system of claim 2, wherein said particular wireless client is a hand-held device.

9. The wireless portal server system of claim 2, wherein said particular wireless client is a wireless phone.

10. The wireless portal server system of claim 2, wherein said particular wireless client is a wireless personal computer system.

11. The wireless portal server system of claim 1, wherein said each of said content containers define channels that primarily use content from other channels.

12. The wireless portal server system of claim 11, wherein said content containers comprise a default container having a default list of channels specified for each of said plurality of wireless clients

13. A client aware applications system in a wireless network, comprising:
a portal server;
a plurality of classes of wireless clients, each of said plurality of classes of wireless clients comprising unique identification parameters; and
a client aware content aggregation service for providing content in response to client type identifications of content access requests from wireless clients of said plurality of classes of wireless clients.

14. The client aware system of claim 13, wherein each wireless client within a class of said plurality of classes of wireless clients has a unique identification parameter to distinguish it from other members of said plurality of classes.

15. The client aware system of claim 14, further comprising a client aware content aggregation module coupled to said portal server for aggregating client aware content gathered from a plurality of web pages over the Internet for presentation in a format suitable for each wireless client.

16. The client aware system of claim 15, further comprising hierarchically stored client data defining said plurality of classes of wireless clients.

17. The client aware system of claim 16, wherein said content aggregation service further comprises a client aware content source module for identifying content location over said plurality of web pages in response to the client type information provided by said plurality of classes of wireless clients.

18. The client aware system of claim 16, wherein each of plurality of wireless client has a property attribute that defines its ancestry in said hierarchical stored client data.

19. The client aware system of claim 16, wherein said content aggregation service further comprises a client request dispatcher for performing client lookups to determine the client type of a client requesting access to said portal server.

20. The client aware system of claim 19, wherein said client request dispatcher further performs a hierarchical search of said hierarchically stored client data to retrieve the appropriate aggregated content for a particular wireless client.

21. The client aware system of claim 20, wherein said content aggregation service further comprises client content mapping logic for mapping each one of said plurality of wireless clients in said hierarchical client data to a corresponding one of a plurality of content containers.

22. The client aware system of claim 21, wherein said mapping logic further maps a plurality of said wireless clients to a corresponding one of said plurality of content containers.

23. The client aware system of claim 22, wherein said content aggregation service further comprises a channel list module for storing a list of predefined content channels available in said wireless portal server.

24. A method of aggregating content for a wireless client in a wireless portal server, comprising:
scraping and aggregating content from a variety of sources;
providing a hierarchical indexing scheme to uniquely identify content in a client specific manner; and
providing content to a plurality of wireless clients accessing the wireless portal server in an aggregated manner.

25. The method of claim 24, wherein said scraping and aggregating content from a variety of sources comprise aggregating predefined content into a plurality channels in said wireless portal server.

26. The method of claim 25, wherein each of said plurality of wireless clients comprises a unique property attribute that defines its ancestry in said plurality of wireless clients.

27. The method of claim 26, wherein aggregated content of said scraping and aggregating content is hierarchically provided to each of said plurality of wireless clients.
